(19) United States
(12) Patent Application Publication
(10) Pub. No.: US 2025/0079709 A1
(43) Pub. Date: Mar. 6, 2025

(54) ANTENNA STRUCTURE AND IMAGE DISPLAY DEVICE

(71) Applicant: DONGWOO FINE-CHEM CO., LTD., Jeollabuk-do (KR)

(72) Inventors: YOON HO HUH, Jeollabuk-do (KR); DO HYOUNG KWON, Jeollabuk-do (KR)

(21) Appl. No.: 18/822,625

(22) Filed: Sep. 3, 2024

(30) Foreign Application Priority Data
Sep. 4, 2023 (KR) 10-2023-0117008

(51) Int. Cl. H01Q 9/04; H01Q 1/38

(52) U.S. Cl. CPC H01Q 9/0407; H01Q 1/38

(57) ABSTRACT

An antenna structure includes a dielectric layer, an antenna unit disposed on the dielectric layer and comprising a radiator, a signal pad and a transmission line connecting the radiator and the signal pad to each other, and a ground separated from the antenna unit in a thickness direction with the dielectric layer interposed therebetween. At least one of a shortest distance between the ground and the radiator in the thickness direction, a shortest distance between the ground and the transmission line in the thickness direction, and a shortest distance between the ground and the signal pad in the thickness direction is different.

### CROSS-REFERENCE TO RELATED APPLICATION AND CLAIM OF PRIORITY

This application claims the benefit under 35 USC § 119 of Korean Patent Application No. 10-2023-0117008 filed on Sep. 4, 2023, in the Korean Intellectual Property Office, the entire disclosure of which is incorporated herein by reference for all purposes.

### BACKGROUND

### 1. Technical Field

The present invention relates to an antenna structure and an image display device. More particularly, the present invention relates to an antenna structure including an antenna unit and a dielectric layer, and an image display device including the same.

### 2. Background Art

As information technologies have been developed, a wireless communication technology such as Wi-Fi, Bluetooth, etc., is being applied to or embedded in image display devices, electronic devices and architecture.

Additionally, according to developments of mobile communication technology, an antenna for performing a communication in high-frequency or ultra-high-frequency band is applied to public transportation such as a bus and a subway, architectural structures, various mobile devices, etc. For example, an antenna operable in a high-frequency or ultra-high-frequency communication band of 3G, 4G, 5G, or more may be combined to an image display device, an electronic device, etc.

Further, an electronic device having an image display function and an information input function is being developed by combining a touch panel or a touch sensor where a user can input a command by selecting an instruction on a screen with a human hand or an object.

As the image display device to which the antenna is employed becomes thinner and lighter, a space for the antenna may be also decreased. When the antenna is included together with the display panel and the touch panel in a limited space, electrical and radiation properties of the antenna may be disturbed.

Thus, design of an antenna structure capable of reducing or preventing signal loss and radiation disturbance caused by other electrical devices within a limited space is required.

### SUMMARY

According to an aspect of the present invention, there is provided an antenna structure having improved operational reliability and signaling efficiency.

According to an aspect of the present invention, there is provided an image display device having improved operational reliability and signaling efficiency.
(1) An antenna structure, including: a dielectric layer; an antenna unit disposed on the dielectric layer, the antenna unit including a radiator, a signal pad and a transmission line connecting the radiator and the signal pad to each other; and a ground separated from the antenna unit in a thickness direction with the dielectric layer interposed therebetween, wherein at least one of a shortest distance between the ground and the radiator in the thickness direction, a shortest distance between the ground and the transmission line in the thickness direction, and a shortest distance between the ground and the signal pad in the thickness direction is different.
(2) The antenna structure of the above (1), wherein the shortest distance between the ground and the transmission line is greater than the shortest distance between the ground and the radiator.
(3) The antenna structure of the above (1), wherein the shortest distance between the ground and the transmission line is greater than the shortest distance between the ground and the signal pad.
(4) The antenna structure of the above (1), wherein the radiator, the transmission line and the signal pad are disposed at the same level on the dielectric layer.
(5) The antenna structure of the above (1), wherein the ground includes a first ground layer and a second ground layer disposed at different levels, and the first ground layer is closer to the antenna unit than the second ground layer.
(6) The antenna structure of the above (5), wherein the antenna unit includes a solid portion having a solid structure and a mesh portion having a mesh structure.
(7) The antenna structure of the above (6), wherein the solid portion includes an overlap region that overlaps the first ground layer and a non-overlap region that does not overlap the first ground layer.
(8) The antenna structure of the above (7), wherein the non-overlap region includes the transmission line, and the overlap region includes at least a portion of the signal pad.
(9) An antenna structure, including: a dielectric layer; an antenna unit disposed on the dielectric layer; a first ground layer disposed under the dielectric layer and separated from the antenna unit with the dielectric layer interposed therebetween; and a second ground layer disposed under the first ground layer, wherein a partial area of the antenna unit overlaps the second ground layer and does not overlap with the first ground layer.
(10) The antenna structure of the above (9), wherein the antenna unit includes a radiator, a signal pad and a transmission line connecting the radiator and the signal pad to each other.
(11) The antenna structure of the above (10), wherein the transmission line overlaps the second ground layer and does not overlap the first ground layer.
(12) The antenna structure of the above (11), wherein the radiator and the signal pad are at least partially superimposed over the first ground layer.
(13) An image display device, including: a display panel including a dielectric layer and a conductive element; and an antenna unit disposed on the display panel and separated from the conductive element in a thickness direction with the dielectric layer interposed therebetween, the antenna unit including a radiator a transmission line and a signal pad, wherein at least one of a first shortest distance between the conductive element and the radiator in the thickness direction, a second shortest distance between the conductive element and the transmission line in the thickness direction, and a third shortest distance between the conductive element and the signal pad in the thickness direction is different.
(14) The image display device of the above (13), wherein the second shortest distance is the largest of the first to third shortest distances.
(15) The image display device of the above (13), wherein the conductive element includes a first conductive element and a second conductive element disposed at different levels, wherein each of the radiator, the transmission line and the signal pad overlaps at least one of the first conductive element and the second conductive element in the thickness direction.
(16) The image display device of the above (15), wherein the first conductive element does not overlap the radiator, the transmission line or the signal pad in the thickness direction.
(17) The image display device of the above (15), wherein the first conductive element does not overlap the transmission line in the thickness direction, and the radiator and the signal pad are at least partially superimposed over the first conductive element in the thickness direction.
(18) The image display device of the above (15), wherein the first conductive element serves as an electrode structure of a touch panel or an electrode structure of a display device.
(19) The image display device of the above (15), wherein the second conductive element includes a heat dissipation sheet, a digitizer, an electromagnetic wave shielding layer, a pressure sensor, a fingerprint sensor or a SUS plate of the image display device.

An antenna structure according to embodiments of the present invention may include an antenna unit, a dielectric layer and a ground separated from the antenna unit with the dielectric layer interposed therebetween. A distance between the antenna unit and the ground may be different at different regions of the antenna structure. Signal properties of the antenna may be improved by adjusting a thickness of the dielectric layer under the antenna unit.

The antenna unit may include a radiator, a transmission line and a signal pad. The transmission line may be disposed farther from the ground in a thickness direction than the radiator and the signal pad. Accordingly, a line loss may be reduced, and signal efficiency and gain may be increased.

Even when an overall thickness of the antenna structure is reduced, a relatively thick dielectric region may be formed under the transmission line. Accordingly, a thin-layered antenna structure may be implemented while improving spatial efficiency, and an antenna gain may be increased.

The ground may include a plurality of ground layers disposed at different levels. A ground layer closest to the antenna unit of the ground layers may partially overlap the antenna unit. A ground efficiency may be further improved by the plurality of ground layers.

A metallic member of an image display device may be provided as the ground layers. For example, electrodes and wirings of a display panel or a touch panel, or a metal sheet such as a heat dissipation sheet or a SUS plate may be used as the ground layer. Accordingly, signal properties of the antenna structure may be improved without adding an additional separate dielectric layer and an additional ground electrode.

### BRIEF DESCRIPTION OF THE DRAWINGS

FIG. 1 is a schematic cross-sectional view illustrating an antenna structure in accordance with example embodiments.

FIG. 2 is a schematic plan view illustrating an antenna structure in accordance with example embodiments.

FIG. 3 is a schematic cross-sectional view illustrating an antenna structure in accordance with example embodiments.

FIG. 4 is a schematic cross-sectional view illustrating an antenna structure in accordance with example embodiments.

FIG. 5 is a schematic plan view illustrating an antenna structure in accordance with example embodiments.

FIG. 6 is a schematic cross-sectional view illustrating an image display device in accordance with example embodiments.

FIG. 7 is a schematic plan view illustrating an image display device in accordance with example embodiments.

FIG. 8 is a schematic cross-sectional view illustrating an image display device in accordance with example embodiments.

FIG. 9 is a graph showing an antenna gain of the antenna structure according to Examples and Comparative Example.

FIG. 10 is a graph showing an antenna gain at a maximum resonance frequency according to a thickness ratio (D₂/D₁) of a dielectric layer.

FIG. 11 is a graph showing an antenna gain of an antenna structure according to Examples.

FIG. 12 is a graph showing an antenna gain at a maximum resonance frequency according to a ratio (L1/(L1+L2)) of an overlap region.

### DETAILED DESCRIPTION OF THE EMBODIMENTS

According to exemplary embodiments of the present invention, an antenna structure including a dielectric layer and an antenna unit. According to exemplary embodiments of the present invention, an image display device including an antenna structure is also provided.

The antenna unit may be, e.g., a microstrip patch antenna fabricated in the form of a transparent film. A sensor element including the antenna unit may be applied to, e.g., a communication device for high-frequency or ultra-high-frequency (e.g., 3G, 4G, 5G or more) mobile communication.

Hereinafter, the present invention will be described in detail with reference to the accompanying drawings. However, those skilled in the art will appreciate that such embodiments described with reference to the accompanying drawings are provided to further understand the spirit of the present invention and do not limit subject matters to be protected as disclosed in the detailed description and appended claims.

The terms “first”, “second”, “third”, “fourth”, “one end”, “other end”, “upper side”, “lower side”, “upper side”, “lower side”, etc., as used herein are not intended to limit an absolute position or order, but is used in a relative sense to distinguish different components or elements.

Sizes of configurations/structures illustrated in the accompanying drawings can be exaggerated for convenience of descriptions, and the present disclosure is not limited to the sizes illustrated in the drawings.

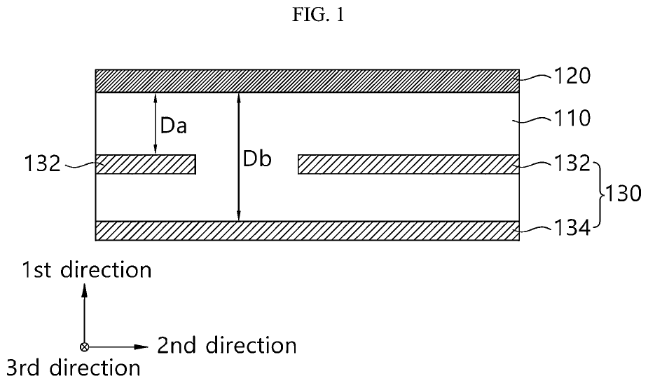

FIG. 1 is a schematic cross-sectional view illustrating an antenna structure in accordance with example embodiments.

Referring to FIG. 1, the antenna structure may include a dielectric layer 110, an antenna unit 120 and a ground 130. The antenna unit 120 may be disposed on the dielectric layer 110.

The ground 130 may be disposed under the antenna unit 120. For example, the ground 130 may be separated from the antenna unit 120 with the dielectric layer 110 interposed therebetween.

The antenna unit 120 and the ground 130 may be at least partially superimposed on each other in a first direction (e.g., a thickness direction). A capacitance may be formed between the antenna unit 120 and the ground 130 to implement vertical radiation properties in the first direction.

The dielectric layer 110 may include an insulating material having a predetermined dielectric constant. The dielectric layer 110 may include, e.g., a transparent resin material.

For example, the dielectric layer 110 may include, e.g., a transparent resin material. For example, the dielectric layer 110 may include a polyester-based resin such as polyethylene terephthalate, polyethylene isophthalate, polyethylene naphthalate and polybutylene terephthalate; a cellulose-based resin such as diacetyl cellulose and triacetyl cellulose; a polycarbonate-based resin; an acrylic resin such as polymethyl (meth)acrylate and polyethyl (meth)acrylate; a styrene-based resin such as polystyrene and an acrylonitrile-styrene copolymer; a polyolefin-based resin such as polyethylene, polypropylene, a cycloolefin or polyolefin having a norbornene structure and an ethylene-propylene copolymer; a vinyl chloride-based resin; an amide-based resin such as nylon and an aromatic polyamide; an imide-based resin; a polyethersulfone-based resin; a sulfone-based resin; a polyether ether ketone-based resin; a polyphenylene sulfide resin; a vinyl alcohol-based resin; a vinylidene chloride-based resin; a vinyl butyral-based resin; an allylate-based resin; a polyoxymethylene-based resin; an epoxy-based resin; a urethane or acrylic urethane-based resin; a silicone-based resin, etc. These may be used alone or in a combination of two or more therefrom.

The dielectric layer 110 may include an adhesive film such as an optically clear adhesive (OCA), an optically clear resin (OCR), etc.

In some embodiments, the dielectric layer 110 may include an inorganic insulating material such as glass, silicon oxide, silicon nitride, silicon oxynitride, etc.

Capacitance or inductance for the antenna structure may be formed by the dielectric layer 110, so that a frequency band at which the antenna structure may be driven or operated may be adjusted. In some embodiments, a dielectric constant of the dielectric layer 110 may be adjusted in a range from about 1.5 to about 12. If the dielectric constant of the dielectric layer 110 exceeds about 12, a driving frequency may be excessively decreased, and driving in a desired high frequency or ultrahigh frequency band may not be implemented.

The antenna unit 120 and the ground 130 may include a metal, an alloy or a metal oxide having a predetermined conductivity.

In some embodiments, the antenna unit 120 and the ground 130 may include silver (Ag), gold (Au), copper (Cu), aluminum (Al), platinum (Pt), palladium (Pd), chromium (Cr), titanium (Ti), tungsten (W), niobium (Nb), tantalum (Ta), vanadium (V), iron (Fe), manganese (Mn), cobalt (Co), nickel (Ni), zinc (Zn), tin (Sn), molybdenum (Mo), calcium (Ca), or an alloy containing at least one of the above-mentioned metals. These may be used alone or in a combination of two or more therefrom.

In one embodiment, the antenna unit 120 and the ground 130 may include silver (Ag) or a silver alloy (e.g., a silver-palladium-copper (APC) alloy), or copper (Cu) or a copper alloy (e.g., a copper-calcium (CuCa) alloy) for low resistance implementation and fine line width patterning.

In some embodiments, the antenna unit 120 and the ground 130 may include a transparent conductive oxide such as indium tin oxide (ITO), indium zinc oxide (IZO), indium zinc tin oxide (ITZO), zinc oxide (ZnOx), etc.

In some embodiments, the antenna unit 120 may include a stacked structure of a transparent conductive oxide layer and a metal layer. For example, the antenna unit 120 may include a double-layered structure of a transparent conductive oxide layer-metal layer, or a triple-layered structure of a transparent conductive oxide layer-metal layer-transparent conductive oxide layer. In this case, flexible property may be improved by the metal layer, and a signal transmission speed may also be improved by a low resistance of the metal layer. Corrosive resistance and transparency may be improved by the transparent conductive oxide layer.

The antenna unit 120 may include a blackened portion, so that a reflectance at a surface of the antenna unit 120 may be decreased to suppress a visual recognition of the antenna unit due to a light reflectance.

In an embodiment, a surface of the metal layer included in the antenna unit 120 may be converted into a metal oxide or a metal sulfide to form a blackened layer. In an embodiment, a blackened layer such as a black material coating layer or a plating layer may be formed on the antenna unit 120 or the metal layer. The black material or plating layer may include silicon, carbon, copper, molybdenum, tin, chromium, molybdenum, nickel, cobalt, or an oxide, sulfide or alloy containing at least one therefrom.

A composition and a thickness of the blackened layer may be adjusted in consideration of a reflectance reduction effect and an antenna radiation property.

A distance between the antenna unit 120 and the ground 130 may be different in different regions of the antenna structure. The distance between the antenna unit 120 and the ground 130 may be determined in consideration of dielectric properties, flexibility, thickness, etc., according to the region of the antenna unit 120. Accordingly, an antenna gain, a radiation directivity, etc., may be further improved.

Additionally, the distance between the antenna unit 120 and the ground 130 may be adjusted in consideration of a space, a size, etc., of an object to which the antenna is applied (e.g., an image display device). Accordingly, signal properties and radiation reliability of the antenna unit 120 may be achieved while efficiently applying the antenna structure within a limited space.

In example embodiments, the ground 130 may include a plurality of ground layers disposed at different levels. For example, the ground 130 may include a first ground layer 132 disposed under the antenna unit 120 and a second ground layer 134 disposed under the first ground layer 132.

A shortest distance Da in the first direction between the first ground layer 132 and the antenna unit 120 and a shortest distance Db in the first direction between the second ground layer 134 and the antenna unit 120 may be different from each other.

In some embodiments, the first ground layer 132 may partially overlap the antenna unit 120 in the first direction. For example, a portion of the antenna unit 120 may not overlap the first ground layer 132 in the first direction. Accordingly, the thickness of the dielectric layer 110 may be increased under a region of the antenna unit 120 that does not overlap the first ground layer 132.

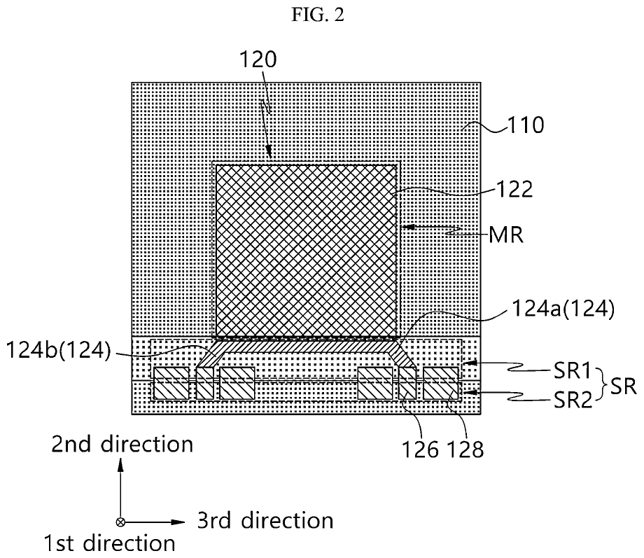

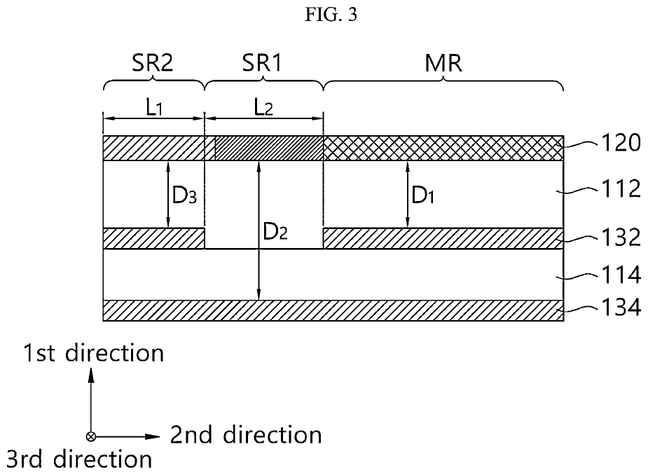

FIG. 2 is a schematic plan view illustrating an antenna structure in accordance with example embodiments. FIG. 3 is a schematic cross-sectional view illustrating an antenna structure in accordance with example embodiments. For example, FIG. 2 is a schematic view of the antenna structure when observed in the first direction, and FIG. 3 is a schematic view of then antenna structure when observed in the third direction.

Referring to FIGS. 2 and 3, the antenna unit 120 may include a radiator 122, a transmission line 124 and a signal pad 126.

For example, the radiator 122 has a polygonal plate shape. The transmission line 124 has a smaller width than that of the radiator 122 and may be connected to at least one end portion of the radiator 122. The radiator 122 and the transmission line 124 may be formed as a single member integrally connected to each other.

A target resonance frequency of the antenna may be adjusted according to the shape/size of the radiator 122. In a non-limiting embodiment, the radiator 122 may be designed to be radiated in a high frequency/ultra-high frequency band of 3G, 4G, 5G or more. For example, a radiation band in a frequency band of 0.5 GHz or more, 1 GHz or more, 10 GHz or more, 20 GHz or more, 30 GHz or more, or 40 GHz or more may be implemented through the radiator 122.

The transmission line 124 may include a first transmission line 124a and a second transmission line 124b connected to the radiator 122 while facing each other. Accordingly, two polarization directions (double polarization) may be provided in one radiator 122.

In some embodiments, each of the first transmission line 124a and the second transmission line 124b may be connected to both ends (e.g., both vertices) of a lower side of the radiator 122.

The first transmission line 124a and the second transmission line 124b may be branched from the radiator 122 to extend in different directions. For example, an angle formed by extending directions of the first transmission line 124a and the second transmission line 124b may be substantially about 90°. For example, the extending directions of the first transmission line 124a and the second transmission line 124b may be orthogonal to each other. In an embodiment, the first transmission line 124a and the second transmission line 124b may extend toward a center of the radiator 122.

The signal pad 126 may be connected to a terminal end portion of the transmission line 124. The transmission line 124 may electrically connect the radiator 122 and the signal pad 126 to each other.

In an embodiment, the signal pad 126 may be a single member substantially integral with the transmission line 124. In this case, the terminal end portion of the transmission line 124 may serve as the signal pad 126.

In some embodiments, the radiator 122, the transmission line 124 and the signal pad 126 may be disposed at the same level on the dielectric layer 110.

In example embodiments, at least one of a shortest distance D₁ between the ground 130 and the radiator 122 in the first direction, a shortest distance D₂ between the ground 130 and the transmission line 124, and a shortest distance D₃ between the ground 130 and the signal pad 126 may be different.

In some embodiments, the first ground layer 132 may not overlap the transmission line 124 in the first direction. For example, the transmission line 124 may overlap the second ground layer 134 and may not overlap the first ground layer 132.

Accordingly, a thickness of a dielectric region under the transmission line 124 may be relatively increased, and the antenna gain and the signal efficiency may be improved by suppressing a line loss. Further, for example, even when an overall thickness of the antenna structure is decreased, the dielectric region under the transmission line 124 may maintain a predetermined thickness. Therefore, a thin-layered structure of the antenna structure may be implemented while suppressing signal and feeding loss.

In some embodiments, the shortest distance D₂ between the ground 130 and the transmission line 124 may be greater than the shortest distance D₁ between the ground 130 and the radiator 122. For example, the first ground layer 132 may not overlap the transmission line 124 in the first direction, and may be at least partially covered by the radiator 122 in the first direction.

A thickness of a region between the radiator 122 and the ground 130 which may serve as, e.g., lower dielectric region of the radiator 122 may be decreased so that the antenna unit may be easily inserted into a limited space, and a thickness of the lower dielectric region of the transmission line 124 may be relatively increased. Thus, a spatial efficiency of the antenna structure may be improved while preventing the line loss in a high frequency band.

In an embodiment, the antenna structure may satisfy Equation 1 below.

$$1 < {D}_{2} / {D}_{1} \leq 4.0 \qquad [ Equation l ]$$

In Equation 1, D₁ is the shortest distance in the first direction between the ground 130 and the radiator 122, and D₂ is the shortest distance in the first direction between the ground 130 and the transmission line 124. In the above range, the line loss may be further suppressed, and thus the antenna gain may be enhanced and the spatial efficiency of the antenna structure may be improved.

In some embodiments, 1<D₂/D₁≤3.6, 1.1≤D₂/D₁≤3.5, 1.17≤D₂/D₁≤3.5, 1.5≤D₂/D₁≤3.4, 1.7≤D₂/D₁≤3.4, preferably 2.1≤D₂/D₁≤3.4.

In an embodiment, the radiator 122 may be at least partially superimposed over the first ground layer 132 and the second ground layer 134. The first ground layer 132 and the second ground layer 134 may form a hybrid ground, so that a radiation directivity and signal properties may be further improved.

In some embodiments, the shortest distance D₂ between the ground 130 and the transmission line 124 may be greater than the shortest distance D₃ between the ground 130 and the signal pad 126. For example, the first ground layer 132 may be at least partially covered by the signal pad 126 in the first direction.

In an embodiment, the antenna structure may satisfy Equation 2 below.

$$1 < {D}_{2} / {D}_{3} \leq 4.0 \qquad [ Equation 2 ]$$

In Equation 2, D₂ is the shortest distance in the first direction between the ground 130 and the transmission line 124, and D3 is the shortest distance in the first direction between the ground 130 and the signal pad 126. In the above range, the line loss may be further suppressed, and thus the antenna gain and the spatial efficiency of the antenna structure may be enhanced.

In some embodiments, 1<D₂/D₃≤3.6, 1.1≤D₂/D₃≤3.5, 1.17≤D₂/D₃≤3.5, 1.5≤D₂/D₃≤3.4, or 1.7≤D₂/D₃≤3.4. Preferably, 2.1≤D₂/D₃≤3.4.

In an embodiment, the shortest distance D₁ in the first direction between the ground 130 and the radiator 122, and the shortest distance D₃ in the first direction between the ground 130 and the signal pad 126 may be substantially the same. In an embodiment, the shortest distance between the ground 130 and the radiator 122 in the first direction, and the shortest distance between the ground 130 and the signal pad 126 in the first direction may be different from each other.

In example embodiments, the dielectric layer 110 may have a multi-layered structure. For example, a first dielectric layer 112 may be interposed between the antenna unit 120 and the first ground layer 132, and a second dielectric layer 114 may be interposed between the first ground layer 132 and the second ground layer 134. The second dielectric layer 114 may serve as a base layer of the antenna structure.

In example embodiments, the antenna unit 120 may include a solid portion SR having a solid structure and a mesh portion MR having a mesh structure.

In some embodiments, the mesh portion MR may be disposed on an object to which the antenna structure is applied, e.g., in a display area of an image display device. Accordingly, a visual recognition of the antenna structure may be prevented.

In an embodiment, the mesh portion MR may include at least a portion of the radiator 122. For example, the radiator 122 may be at least partially formed in the mesh structure. In an embodiment, the transmission line 124 may also at least partially include the mesh structure.

In some embodiments, the solid portion SR may be disposed in a non-visible area of the object. A resistance of the antenna unit 120 may be reduced by the solid portion SR, and the signal and feeding efficiency may be improved.

In an embodiment, the solid portion SR may include the transmission line 124 and the signal pad 126. For example, the transmission line 124 and the signal pad 126 may be formed as solid metal or alloy patterns.

In an embodiment, the solid portion SR may include at least a portion of the radiator 122. For example, at least a portion of the radiator 122 may be formed as a solid metal or alloy pattern.

In some embodiments, the solid portion SR may be partially superimposed over the first ground layer 132 in the first direction. For example, the solid portion SR may include an overlap region SR2 overlapping the first ground layer 132 and a non-overlap region SR1 not overlapping the first ground 130.

In an embodiment, the transmission line 124 may be disposed in the non-overlap region SR1. The signal pad 126 and the radiator 122 may be disposed in the overlap region SR2. In an embodiment, the signal pad 126 and the radiator 122 may also be partially disposed in the non-overlap region SR1.

In an embodiment, the antenna structure may satisfy Equation 3 below.

$$0.1 \leq {L}_{1} / ( {L}_{1} + {L}_{2} ) \leq 1. \qquad [ Equation 3 ]$$

In Equation 3, L₁ is a length of the overlap region SR2 in the second direction, and L₂ is a length of the non-overlap region SR1 in the second direction. The second direction is parallel to an upper surface of the antenna structure, and may be a direction in which the antenna unit 120 or the transmission line 124 extends.

A relatively thick dielectric region may be formed under a signal/feeding path within the above range, thereby further enhancing the signal efficiency and antenna gain. Additionally, a bonding region between the antenna structure and an external device, e.g., a circuit board, may be achieved, thereby preventing charging, interference and discharging to improve stability.

In an embodiment, 0.1≤L₁/(L₁+L₂)≤0.8, or 0.1≤L₁/(L₁+L₂)≤0.6.

Preferably, the length of the non-overlap region SR1 may be greater than or equal to the length of the overlap region SR2. For example, 0.1≤L₁/(L₁+L₂)≤0.5, or 0.1≤L₁/(L₁+L₂)≤0.4.

In some embodiments, a ground pad 128 may be disposed around the signal pad 126. For example, a pair of the ground pads 128 may be disposed to face each other with the signal pad 126 interposed therebetween. The ground pad 128 may be formed as a solid metal or alloy pattern. The ground pad 128 may be physically and electrically separated apart from the signal pad 126.

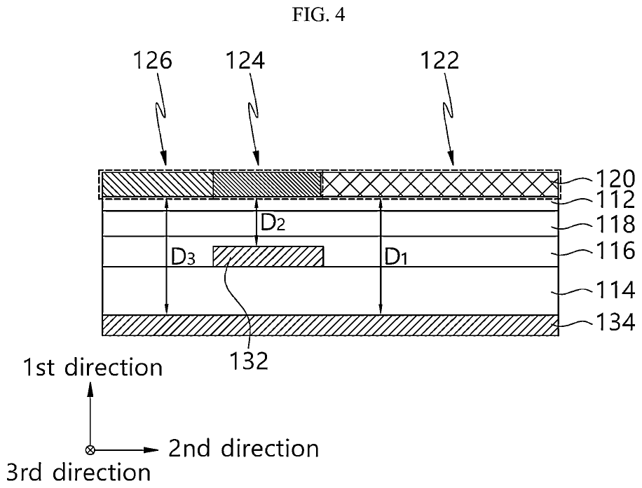

FIG. 4 is a schematic cross-sectional view illustrating an antenna structure in accordance with example embodiments.

Referring to FIG. 4, the first ground layer 132 may at least partially overlap by the transmission line 124 in the first direction. The first ground layer 132 may not overlap the radiator 122 or the signal pad 126 in the first direction.

For example, a shortest distance D₂ between ground 130 and transmission line 124 may be smaller than a shortest distance D₁ between ground 130 and radiator 122 and/or a shortest distance D₃ between ground 130 and signal pad 126.

In an embodiment, the dielectric layer 110 may include an insulating layer 116 and an adhesive layer 118. For example, the first ground layer 132 and the insulating layer 116 may be stacked on the second dielectric layer 114, and the first dielectric layer 112 may be combined with the first ground layer 132 by the adhesive layer 118 or may be stacked on the insulating layer 116.

The insulating layer 116 may include the above-mentioned organic insulating material or inorganic insulating material. The adhesive layer 118 may include an adhesive or pressure sensitive adhesive film such as an optical transparent adhesive (OCA) or an optical transparent resin (OCR).

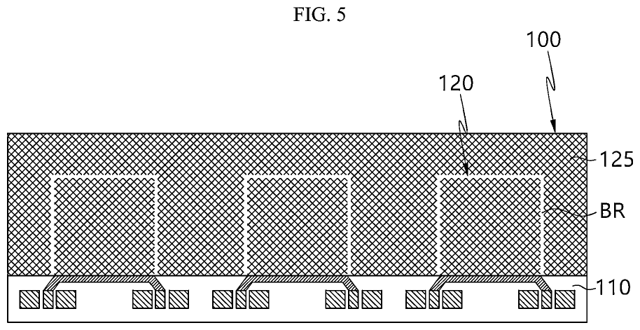

FIG. 5 is a schematic plan view illustrating an antenna structure in accordance with example embodiments.

Referring to FIG. 5, the antenna structure may further include a dummy mesh pattern 125.

In an embodiment, a dummy mesh pattern 125 may be formed around the mesh portion MR. The dummy mesh pattern 125 may include a mesh structure substantially the same as that included in the mesh portion MR. Accordingly, a spatial distribution of conductive patterns around the radiator 122 and/or the transmission line 124 may become uniform, thereby preventing the antenna unit 120 from being visually recognized.

The dummy mesh pattern 125 may be formed together with the radiator 122 and/or the transmission line 124. The dummy mesh pattern 125 may be physically isolated or separated from the radiator 122 and the transmission line 124 by a separation region BR.

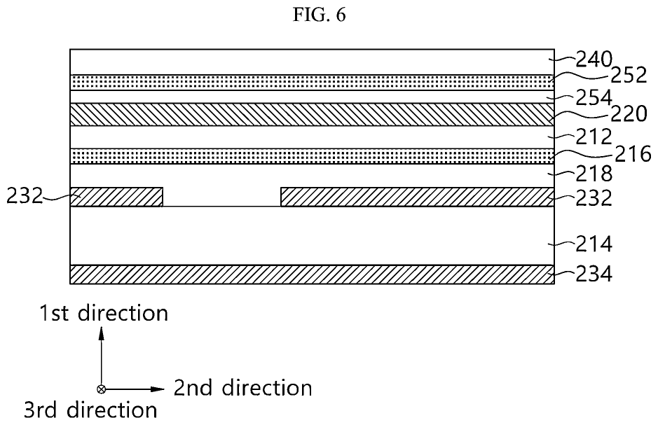

FIG. 6 is a schematic cross-sectional view illustrating an image display device in accordance with example embodiments.

Referring to FIG. 6, an image display device may include a display panel and an antenna unit 220 disposed on the display panel.

The display panel may include a dielectric layer and conductive elements 232 and 234. The antenna unit 220 may be electrically and physically separated from the conductive elements 232 and 234 with the dielectric layer interposed therebetween.

The conductive elements 232 and 234 may serve as a ground of the above-described antenna structure. For example, a capacitance and an inductance may be formed between the antenna unit 220 and the conductive elements 232 and 234 by the dielectric layer.

In an embodiment, the conductive elements may include a first conductive element 232 and a second conductive element 234. For example, the first conductive element 232 may serve as the first ground layer of the antenna structure, and the second conductive element 234 may serve as the second ground layer of the antenna structure.

In an embodiment, the first conductive element 232 and the second conductive element 234 may be electrically and physically separated by the dielectric layer. In an embodiment, the first conductive element and the second conductive element may be connected to each other by a via or a contact penetrating the dielectric layer.

In some embodiments, the dielectric layer may include a base layer 214, an insulating layer 218 and an antenna dielectric layer 212. For example, the base layer 214 may be stacked on the second conductive element 234, and the first conductive element 232 and the insulating layer 218 may be formed on the base layer 214. The antenna dielectric layer 212 may be disposed on the insulating layer 218.

The base layer 214, the insulating layer 218 and the antenna dielectric layer 212 may include the above-described transparent resin material and insulating material. For example, a dielectric constant of the base layer 214, the insulating layer 218 and the antenna dielectric layer 212 may each be adjusted in a range from about 1.5 to 12. The dielectric constant and an impedance suitable for a desired target frequency may be finely adjusted by using the multi-layered dielectric structure.

A window substrate 240 may be disposed on the antenna unit 220. The window substrate 240 may include, e.g., a hard coating film or a glass substrate such as ultra-thin glass (UTG).

In an embodiment, an antenna insulating layer 254 may be formed on the antenna unit 220. In an embodiment, a first adhesive 216 may be disposed between the antenna dielectric layer 212 and the insulating layer 218, and a second adhesive layer 252 may be disposed between the antenna insulating layer 254 and the window substrate 240.

In some embodiments, an electrode structure included in the display panel, e.g., an electrode structure of a display element or an electrode structure of a touch panel may serve as the first conductive element 232 of the display panel.

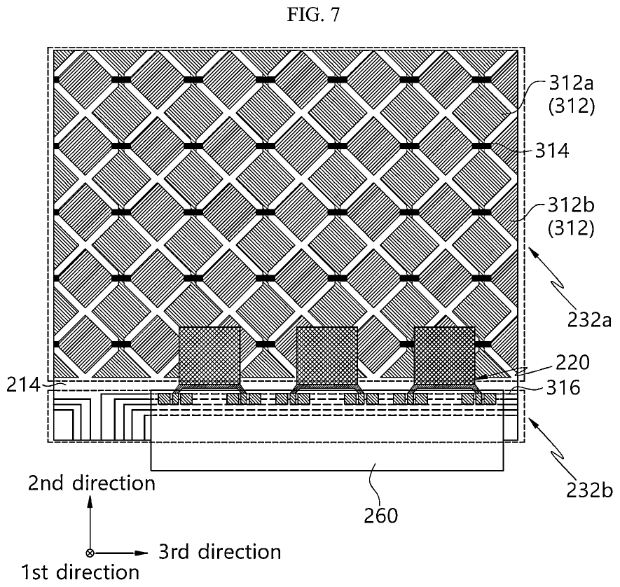

FIG. 7 is a schematic plan view illustrating an image display device in accordance with example embodiments. For convenience of descriptions, illustration of an element between the antenna unit and a touch panel is omitted in FIG. 7.

Referring to FIG. 7, an electrode structure of the touch panel may serve as the first conductive element 232. For example, the electrode structure of the touch panel may overlap the antenna unit 220.

For example, the electrode structure of the touch panel may include electrodes or wirings such as a sensing electrode 312, a bridge electrode 314, a trace 316, etc.

The sensing electrode 312, the bridge electrode 314 and the trace 316 may be arranged on the base layer 214. The sensing electrode 312, the bridge electrode 314 and the trace 316 may be separated from the antenna unit 220 in the first direction with the insulating layer and/or the antenna dielectric layer interposed therebetween.

In an embodiment, the sensing electrode 312 may include sensing electrodes 312 arranged in different directions from a planar direction. For example, the sensing electrode 312 may include first sensing electrodes 312a arranged in the second direction and second sensing electrodes 312b arranged in the third direction.

The first sensing electrodes 312a and the second sensing electrodes 312b may be disposed at the same level on the base layer 214. The bridge electrode 314 may electrically connect the second sensing electrodes 312b neighboring each other.

The traces 316 may be connected to the sensing electrodes 312. For example, the traces 316 may be branched from the first sensing electrodes 312a and the second sensing electrodes 312b and may extend to a peripheral region of the touch panel.

An electrical signal may be generated by a change in capacitance through the first sensing electrodes 312a and the second sensing electrodes 312b. For example, the electrical signal may be transmitted to a driving circuit through the trace 316.

The radiator of the antenna unit 220 may partially cover the sensing electrodes 312 and the bridge electrodes 314 in the first direction. For example, the sensing electrodes 312 or the bridge electrodes 314 of the touch panel may serve as a ground layer 232a of the radiator.

The signal pad of the antenna unit 220 may partially cover the traces 316 in the first direction. For example, the traces 316 of the touch panel may serve as a ground layer 232b of the signal pad.

The electrode structure of the touch panel may not overlap the transmission line of the antenna unit 220 in the first direction.

In example embodiments, the antenna unit 220 may be electrically connected to a circuit board 260. For example, the antenna unit 220 may be attached to or bonded to the circuit board 260 through the signal pad.

An antenna driving IC chip and the antenna unit 220 may be electrically connected through the circuit board 260, and signal transmission/reception and/or feeding to the antenna unit 220 may be performed.

In an embodiment, the circuit board 260 may include a rigid circuit board or a flexible printed circuit board (FPCB).

In an embodiment, the antenna unit 220 and the circuit board 260 may be attached or bonded to each other through a conductive intermediate structure. For example, the signal pad, the conductive intermediate structure and the circuit board 260 may be sequentially contacted or stacked.

In an embodiment, the conductive intermediate structure may include an anisotropic conductive film (ACF).

The circuit board 260 (e.g., a flexible printed circuit board) may be bent under the touch panel or the display panel to be disposed at a rear side of the image display device, and may extend toward an intermediate circuit board 260 on which the antenna driving IC chip is mounted.

The circuit board 260 and the intermediate circuit board may be bonded or interconnected through a connector, so that feeding and driving control of the antenna unit may be performed by the antenna driving IC chip.

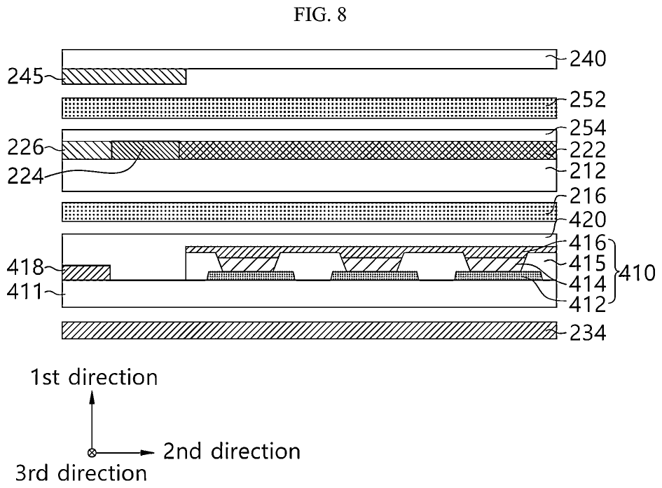

FIG. 8 is a schematic cross-sectional view illustrating an image display device in accordance with example embodiments.

Referring to FIG. 8, an electrode structure of the display device 410 may serve as the first conductive element. For example, the antenna unit 220 may be partially superimposed over the electrode structure of the display device 410.

For example, the electrode structure of the display device 410 may include electrodes or wirings such as a gate electrode, source/drain electrodes, a pixel electrode, a common electrode, data lines, scan lines, etc., included in a thin film transistor (TFT) array panel.

A pixel electrode 412, a pixel defining layer 415, a display layer 414, a common electrode 416 and electrode lines 418 may be formed on a panel substrate 411. The electrode lines 418 may include a data line, a scan line, etc.

The pixel defining layer 415 may be formed on the panel substrate 411 to expose the pixel electrode 412. A pixel region may be defined by the pixel defining layer 415. A display layer 414 may be formed on the pixel electrode 412. For example, the display layer 414 may include a liquid crystal layer or an organic light emitting layer.

The common electrode 416 may be disposed on the pixel defining layer 415 and the display layer 414. For example, the pixel electrode 412 may serve as an anode of the display panel, and the common electrode 416 may serve as a cathode of the display panel.

In an embodiment, an encapsulation layer 420 may be formed on the common electrode 416. The antenna unit 220 may be separated from the electrode structure of the display device 410 with the encapsulation layer 420 interposed therebetween. For example, the encapsulation layer 420 may serve as a dielectric region between the antenna unit 220 and the electrode structure.

In an embodiment, a pixel circuit including a thin film transistor (TFT) array and an insulating layer covering the pixel circuit may be formed on the panel substrate 411. The pixel electrode 412 may be electrically connected to, e.g., a drain electrode of the thin film transistor array on the insulating layer.

In an embodiment, the pixel electrode 412, the common electrode 416 or the electrode lines 418 may serve as the first conductive element. For example, the antenna unit 220 may partially overlap the pixel electrode 412, the common electrode 416 and the electrode lines 418.

In an embodiment, the radiator 222 may overlap the pixel electrode 412, the common electrode 416 and/or the electrode lines 418 in the first direction. In an embodiment, the signal pad 226 may overlap the electrode lines 418 in the first direction.

The electrode structure of the display device 410 may not overlap the transmission line 224 of the antenna unit 220 in the first direction. Accordingly, a dielectric region having a relatively large thickness may be formed under the transmission line 224, and the signal loss may be suppressed and the antenna efficiency/gain may be further improved.

In an embodiment, the second conductive element 234 may have a resistance lower than that of the first conductive element 232.

In some embodiments, a metallic element such as a stainless steel (SUS) plate, a heat dissipation sheet, an electromagnetic wave shielding layer, or a sensor element such as a digitizer, a pressure sensor, a fingerprint sensor, etc., in the display device may be provided as the second conductive element.

In an embodiment, a conductive element of the touch panel may serve as the first conductive element, and a conductive element of the display panel may serve as the second conductive element.

The electrode structures of the image display device may be provided as the ground of the antenna unit 220, so that high-frequency and high-gain signal properties may be implemented without forming a separate ground layer. Accordingly, mechanical design of the image display device and the antenna structure may be easily performed, and the spatial efficiency may be improved.

In an embodiment, a light-shielding pattern 245 may be formed on a peripheral portion of one surface of the window substrate 240. The light-shielding pattern 245 may include a color printing pattern, and may have a single-layered or a multi-layered structure. A display area and a non-display area of the image display device may be defined by the light-shielding pattern 245. For example, the light-shielding pattern 245 may be disposed in the non-display area such as a light-shielding portion or a bezel portion of the image display device.

In some embodiments, the solid portion of the antenna structure may be disposed in the non-display area of the image display device. In an embodiment, at least a portion of the mesh portion of the antenna structure may be disposed in the display area of the image display device.

Hereinafter, preferred embodiments are proposed to more concretely describe the present invention. However, the following examples are only given for illustrating the present invention and those skilled in the related art will obviously understand that various alterations and modifications are possible within the scope and spirit of the present invention. Such alterations and modifications are duly included in the appended claims.

### Experimental Example 1

### Examples 1 to 3 and Comparative Example

A second dielectric layer was stacked on a copper (Cu) sheet, and a conductive layer including Cu was partially formed on the second dielectric layer. A first dielectric layer was formed on the Cu conductive layer, and an antenna unit was formed as illustrated in FIGS. 2 and 3 using a Cu-alloy on the first dielectric layer.

A resonance frequency of the antenna unit was adjusted to about 26 GHz and about 32 GHZ. L₁/(L₁+L₂) of the antenna structure was adjusted to 0.2, and a total length (L₁+L₂) of L₁ and L₂ was set to 450 μm.

D₂/D₃ of the antenna structure was adjusted as shown in Table 1 below. D₂/D₁ of the antenna structure was adjusted to be the same as D₂/D₃.

TABLE 1

| | D₂/D₃ |
|---|---|
| Example 1 | 3.37 |
| Example 2 | 2.05 |
| Example 3 | 1.17 |
| Comparative | 1.00 |
| Example 1 | |

An antenna gain of the radiator of each antenna structure manufactured according to Examples and Comparative Example was measured in a radiation chamber.

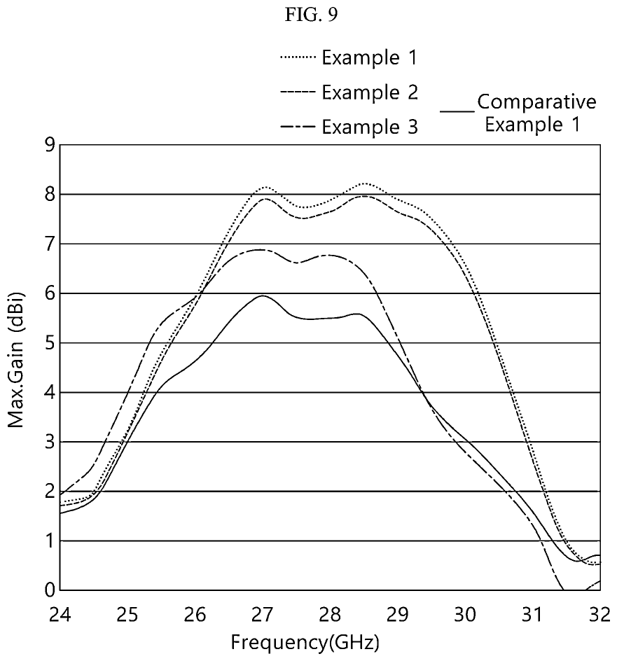

FIG. 9 is a graph showing an antenna gain of the antenna structure according to Examples and Comparative Example.

Referring to FIG. 9, the antenna gain was increased in both 26 GHz and 32 GHz frequency bands in Examples, but the antenna gain of Comparative Example was less than those from Examples.

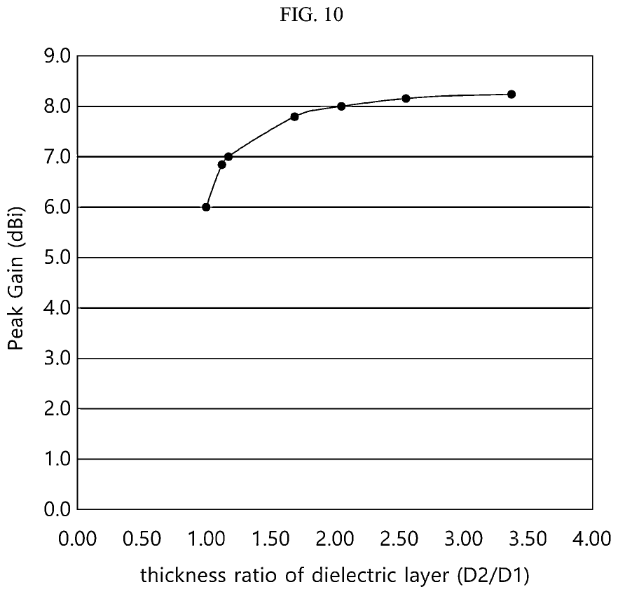

FIG. 10 is a graph showing an antenna gain at a maximum resonance frequency according to a thickness ratio (D₂/D₁) of a dielectric layer.

Referring to FIG. 10, as the thickness ratio of the dielectric layer was increased, the antenna gain at a maximum peak became higher.

### Experimental Example 2

### Example 1 and Examples 4 to 7

A second dielectric layer was stacked on a copper (Cu) sheet, and a conductive layer including Cu was partially formed on the second dielectric layer. A first dielectric layer was formed on the Cu conductive layer, and an antenna unit was formed as illustrated in FIGS. 2 and 3 using a Cu-alloy on the first dielectric layer.

A resonance frequency of the antenna unit was adjusted to about 26 GHZ and about 32 GHZ. D₂/D₁ and D₂/D₃ of the antenna structure were adjusted to 3.37, and a total length (L₁+L₂) of L₁ and L₂ was set to 450 μm.

L₁/(L₁+L₂) of the antenna structure was adjusted as shown in Table 2 below.

TABLE 2

| | L₁/(L₁ + L₂) |
|---|---|
| Example 1 | 0.20 |
| Example 4 | 0.40 |
| Example 5 | 0.60 |
| Example 6 | 0.80 |
| Example 7 | 1.00 |

An antenna gain of the radiator of each antenna structure manufactured according to Examples and Comparative Example was measured in a radiation chamber.

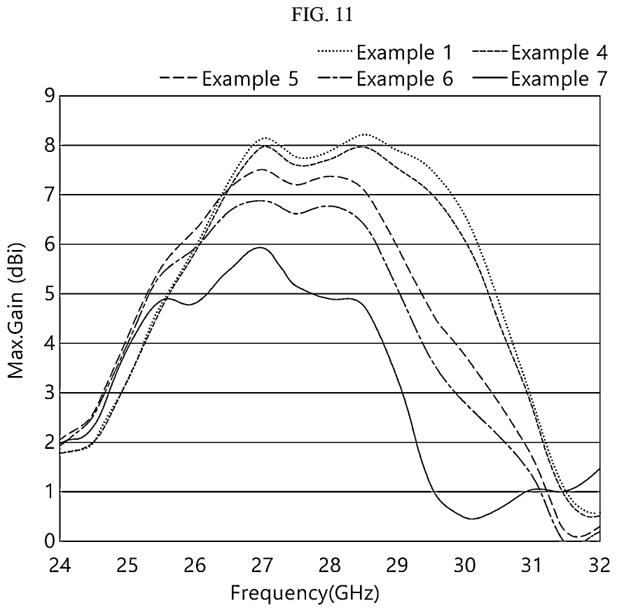

FIG. 11 is a graph showing an antenna gain of an antenna structure according to Examples.

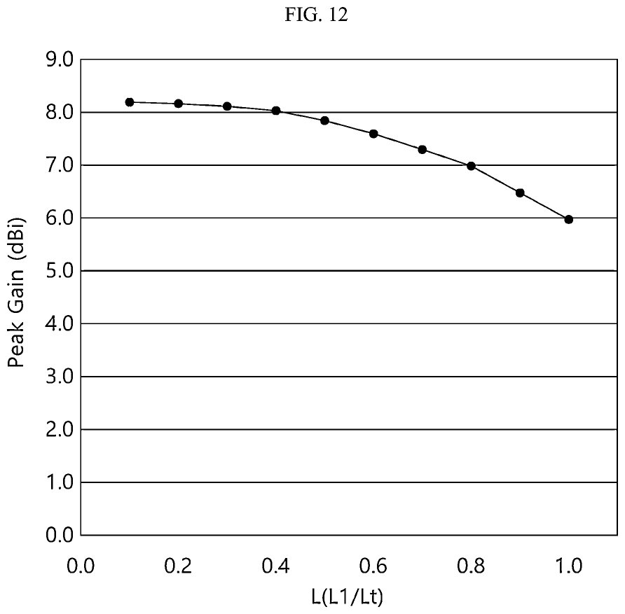

FIG. 12 is a graph showing an antenna gain at a maximum resonance frequency according to a ratio (L₁/(L₁+L₂)) of an overlap region.

Referring to FIGS. 11 and 12, as the ratio of the overlap region of a solid portion was decreased, the antenna gain became higher.

What is claimed is:

1. An antenna structure comprising:
a dielectric layer;
an antenna unit disposed on the dielectric layer, the antenna unit comprising a radiator, a signal pad and a transmission line connecting the radiator and the signal pad to each other; and
a ground separated from the antenna unit in a thickness direction with the dielectric layer interposed therebetween,
wherein at least one of a shortest distance between the ground and the radiator in the thickness direction, a shortest distance between the ground and the transmission line in the thickness direction, and a shortest distance between the ground and the signal pad in the thickness direction is different.

2. The antenna structure of claim 1, wherein the shortest distance between the ground and the transmission line is greater than the shortest distance between the ground and the radiator.

3. The antenna structure of claim 1, wherein the shortest distance between the ground and the transmission line is greater than the shortest distance between the ground and the signal pad.

4. The antenna structure of claim 1, wherein the radiator, the transmission line and the signal pad are disposed at the same level on the dielectric layer.

5. The antenna structure of claim 1, wherein the ground comprises a first ground layer and a second ground layer disposed at different levels, and
the first ground layer is closer to the antenna unit than the second ground layer.

6. The antenna structure of claim 5, wherein the antenna unit includes a solid portion having a solid structure and a mesh portion having a mesh structure.

7. The antenna structure of claim 6, wherein the solid portion includes an overlap region that overlaps the first ground layer and a non-overlap region that does not overlap the first ground layer.

8. The antenna structure of claim 7, wherein the non-overlap region includes the transmission line, and the overlap region includes at least a portion of the signal pad.

9. An antenna structure comprising:
a dielectric layer;
an antenna unit disposed on the dielectric layer;
a first ground layer disposed under the dielectric layer and separated from the antenna unit with the dielectric layer interposed therebetween; and
a second ground layer disposed under the first ground layer,
wherein a partial area of the antenna unit overlaps the second ground layer and does not overlap the first ground layer.

10. The antenna structure of claim 9, wherein the antenna unit comprises a radiator, a signal pad and a transmission line connecting the radiator and the signal pad to each other.

11. The antenna structure of claim 10, wherein the transmission line overlaps the second ground layer and does not overlap the first ground layer.

12. The antenna structure of claim 11, wherein the radiator and the signal pad are at least partially superimposed over the first ground layer.

13. An image display device comprising:
a display panel comprising a dielectric layer and a conductive element; and
an antenna unit disposed on the display panel and separated from the conductive element in a thickness direction with the dielectric layer interposed therebetween, the antenna unit comprising a radiator a transmission line and a signal pad,
wherein at least one of a first shortest distance between the conductive element and the radiator in the thickness direction, a second shortest distance between the conductive element and the transmission line in the thickness direction, and a third shortest distance between the conductive element and the signal pad in the thickness direction is different.

14. The image display device of claim 13, wherein the second shortest distance is the largest of the first to third shortest distances.

15. The image display device of claim 13, wherein the conductive element comprises a first conductive element and a second conductive element disposed at different levels,
wherein each of the radiator, the transmission line and the signal pad overlaps at least one of the first conductive element and the second conductive element in the thickness direction.

16. The image display device of claim 15, wherein the first conductive element does not overlap the radiator, the transmission line or the signal pad in the thickness direction.

17. The image display device of claim 15, wherein the first conductive element does not overlap the transmission line in the thickness direction, and the radiator and the signal pad are at least partially superimposed over the first conductive element in the thickness direction.

18. The image display device of claim 15, wherein the first conductive element serves as an electrode structure of a touch panel or an electrode structure of a display device.

19. The image display device of claim 15, wherein the second conductive element includes a heat dissipation sheet, a digitizer, an electromagnetic wave shielding layer, a pressure sensor, a fingerprint sensor or a SUS plate of the image display device.
